(19) United States
(12) Patent Application Publication
(10) Pub. No.: US 2009/0327598 A1
(43) Pub. Date: Dec. 31, 2009

(54) DISK STORAGE APPARATUS AND PROGRAM

(75) Inventors: Tetsuya Tamura, Kanagawa (JP); Kazuya Suzuki, Kanagawa (JP); Nobuharu Sasaki, Saitama (JP); Hajime Nishimura, Kanagawa (JP)

Correspondence Address: WOLF GREENFIELD & SACKS, P.C., 600 ATLANTIC AVENUE, BOSTON, MA, 02210-2206, US

(73) Assignee: Sony Corporation, Tokyo (JP)

(21) Appl. No.: 12/486,040

(22) Filed: Jun. 17, 2009

(30) Foreign Application Priority Data
Jun. 25, 2008 (JP) 2008-165741

(51) Int. Cl. G06F 12/00; G06F 12/02

(52) U.S. Cl. 711/112; 711/170; 711/E12.001; 711/E12.002

(57) ABSTRACT

Disclosed is a disk storage apparatus to control writing to a storage medium having a storage area to which a first address space is allocated and whose transfer rate spatially changes, including a command reception section and control section. The command reception section receives a write command from a host apparatus and containing an address of the first address space. The control section performs control to divide the storage area into zones, pre-define a second address space where blocks are successively allocated to the zones from a beginning address of the first address space, replace, for each of the write commands received by the command reception, an address of the first address space contained therein with an address of the second address space, select one of the zones as a write target zone by cyclical changing, and perform a writing process to the storage medium for each selected zone.

### BACKGROUND OF THE INVENTION

1. Field of the Invention

The present invention relates to a disk storage apparatus that stores data using a disk-shaped storage medium such as a hard disk drive (HDD) and to a program used for the disk storage apparatus.

2. Description of the Related Art

Generally, a host apparatus does not take into consideration data placements on a disk in a disk storage apparatus such as a hard disk apparatus. Thus, as data is repeatedly written to and read from a disk, data of one file is increasingly fragmented and recorded on a plurality of locations. As a result, an access rate for the disk decreases viewed from a standpoint of the host apparatus.

Meanwhile, a disk storage apparatus such as a hard disk apparatus performs processes in an order in which I/O requests are generated without considering locations accessed therebefore or thereafter, and thus the apparatus tends to wastefully and frequently perform a seek operation. This situation is inevitable when the host apparatus is an information processing apparatus that operates under the control of a multi-task operating system (OS). This is because it is extremely complicated to control placements of data and access sequences on the storage medium while taking into account of entire tasks and because many resources are spent to manage them.

However, such a situation is not applied to consumer apparatuses such as a video camera (camcorder) having an imaging section and a recording section. The operations of the consumer apparatuses are generally formulaic. In other words, consumer apparatuses are particularly required to quickly and accurately operate in response to individual operations by a user. As a technique that satisfies this request, disk scheduling is known. Disk scheduling changes execution sequences of many commands that have been queued so as to reduce wasteful frequent seek operation and thereby improve system performance (for example, see, “Operating System”, Iwanami-koza Software Science, p. 343).

As an algorithm of disk scheduling, SCAN is known. In SCAN, a disk head is moved in one direction so that I/O requests are processed in a radial direction of a disk. As is well known, since the hard disk apparatus uses zone-bit recording, a transfer rate on an outer circumference of the disk is higher than a transfer rate on an inner circumference of the disk. Thus, when a file system equally uses an entire surface of the disk and the disk storage apparatus performs disk scheduling based on the SCAN algorithm, a stable transfer rate can be secured (for example, see “Disk Scheduling in Multimedia I/O System”, by Reddy. N, Wyllie. J, Proc, ACM Multimedia 93).

Techniques for placing data on the disk in combination with disk scheduling are disclosed in many patent documents (for example, see Japanese Patent Application Laid-Open No. HEI 9-185864).

### SUMMARY OF THE INVENTION

However, when a consumer apparatus such as a camcorder writes relatively-large-volume data such as a video stream, the consumer apparatus issues a write command such that storage areas of the disk are used in an order of smaller logical block address (LBA) values (from the outer circumference of the disk). In this case, according to a disk scheduling of a SCAN method, there is no problem when the disk has a sufficient free space. However, when the free space becomes smaller, non-used storage areas concentrate at inner circumferential areas where transfer rates are low, and therefore the access rate decreases viewed from a standpoint of a host apparatus.

In view of the above-mentioned circumstances, it is desirable to provide a disk storage apparatus and a program that can secure constantly stable transfer rates viewed from the standpoint of the host apparatus.

According to an embodiment of the present invention, there is provided a disk storage apparatus which controls writing to a storage medium having a storage area to which a first address space constituted of a plurality of blocks has been allocated and whose transfer rate spatially changes. The disk storage apparatus includes a command reception section and a control section. The command reception section receives a write command issued from a host apparatus and containing an address of the first address space. The control section performs control to divide the storage area into a plurality of zones, pre-define a second address space in which the plurality of blocks are successively allocated to the plurality of zones from a block of a beginning address of the first address space, replace, for each of the write commands received by the command reception, an address of the first address space contained therein with an address of the second address space, select one of the zones as a write target zone by cyclical changing, and perform a writing process to the storage medium for each selected zone.

According to the embodiment of the present invention, blocks each having a predetermined capacity of write data transferred from the host apparatus are allocated to a plurality of zones that divide the first address space allocated to the storage area of the storage medium. A write target zone is cyclically changed and one of the zones is selected as the write target zone. A writing process is performed for the selected zone of the storage medium. Thus, a constantly stable data transfer rate viewed from the standpoint of the host apparatus can be secured.

The control section may perform control to prioritize write commands in a descending order of sizes of write data for the write commands and perform the writing process to the storage medium for each selected zone in a priority order of the write commands. Thus, when video data of a relatively large size are transferred as write data from the host apparatus, the data are preferentially written to the storage medium. As a result, the data transfer rate viewed from the standpoint of the host apparatus can be improved. In addition, since the order of write commands is adjusted, the frequency of seek operation that is performed for a short period corresponding to the writing process for a small amount of data can be decreased. From this point of view, a stable data transfer rate can also be secured.

The control section may perform control to prioritize one write command equivalent to a plurality of write commands having continuous addresses as data write targets in the second address space and perform a writing process based on the prioritized write command. Thus, the data transfer rate viewed from the standpoint of the host apparatus can be further improved.

When the number of times of the writing process based on write commands for one of the zones becomes a predetermined upper limit value, regardless of whether a non-processed write command for the zone is left, the control section may perform control so that the writing process based on the non-processed write command is skipped and a writing process for next one of the zones is performed. Thus, while data having a relatively large size are being written to the storage medium, the frequency of the seek operation for a short period corresponding to the writing process performed for data of a relatively small size can be decreased. As a result, the data transfer rate viewed from the standpoint of the host apparatus can be improved.

When the zone corresponding to the non-processed write command for which the writing process is skipped is selected as the write target zone next time, the control section may preferentially perform the writing process based on the non-processed write command. As a result, a situation in which the writing process for data of a small size is not executed for a long time can be prevented.

The control section may perform control to treat storage areas of a plurality of storage media of one of a same type and difference types as one storage area, pre-define a second address space in which the plurality of blocks are successively allocated to the plurality of zones from the block of the beginning address of the first address space allocated to the one storage area, replace, for each of the write commands received by the command reception, the address of the first address space contained therein with the address of the second address space, select one of the zones as the write target zone by cyclically changing, and perform a writing process to the storage medium for each selected zone.

According to another embodiment of the present invention, there is provided a program to control writing to a storage medium having a storage area to which a first address space is allocated and whose transfer rate spatially changes. The program causes a computer built in a disk storage apparatus to function as a command reception section and a control section. The command reception section receives a write command issued from a host apparatus and containing an address of the first address space. The control section performs control to divide the storage area into a plurality of zones, pre-define a second address space in which a plurality of blocks are successively allocated to the plurality of zones from a block of a beginning address of the first address space, replace, for each of the write commands received by the command reception, an address of the first address space contained therein with an address of the second address space, select one of the zones as a write target zone by cyclical changing, and perform a writing process to the storage medium for each selected zone.

As described above, in the disk storage apparatus and program according to the embodiments of the present invention, a constantly stable data transfer rate viewed from the standpoint of the host apparatus can be secured.

These and other objects, features and advantages of the present invention will become more apparent in light of the following detailed description of best mode embodiments thereof, as illustrated in the accompanying drawings.

### BRIEF DESCRIPTION OF DRAWINGS

FIG. 1 is a block diagram showing a structure of a disk storage apparatus according to an embodiment of the present invention;

FIG. 2 is a schematic diagram showing a relationship between an external LBA space and an internal LBA space;

FIG. 3 is a table showing a relationship between external LBAs and internal LBAs;

FIG. 4 is a flowchart showing a procedure performed when a write command is received;

FIG. 5 is a diagram showing a command management table;

FIG. 6 is a diagram showing an example of a command management table at a time when three entries are added to the command management table shown in FIG. 5;

FIG. 7 is a diagram showing an example of a command management table at a time when two entries are added to the command management table shown in FIG. 6; and

FIG. 8 is a flowchart showing a zone-based writing process.

### DESCRIPTION OF PREFERRED EMBODIMENTS

Next, with referenced to the accompanying drawings, embodiments of the present invention will be described.

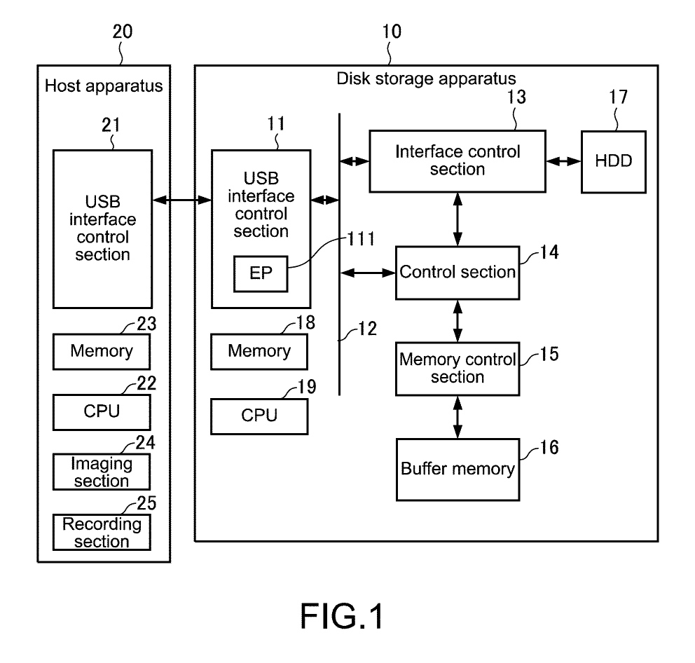

FIG. 1 is a block diagram showing a structure of a disk storage apparatus according to an embodiment of the present invention.

As shown in FIG. 1, a disk storage apparatus 10 includes a universal serial bus (USB) interface control section 11, an internal bus 12, an interface control section 13, a control section 14 (as a command reception section), a memory control section 15, a buffer memory 16, a hard disk drive (HDD) 17, a memory 18, and a central processing unit (CPU) 19.

The USB interface control section 11 is a module that operates in cooperation with a USB interface section 21 of a host apparatus 20 and controls an interface between the disk storage apparatus 10 and the host apparatus 20. The host apparatus 20 is for example an electronic apparatus such as a video camera and a camcorder. The host apparatus 20 includes a CPU 22, a memory 23, an imaging section 24, a recording section 25, and the like. The USB interface control section 11 receives a write command from the USB interface control section 21 of the host apparatus 20 and supplies the write command to the control section 14 through the internal bus 12. In addition, the USB interface control section 11 stores write data transferred from the host apparatus 20 to an end point FIFO (EP) 111 disposed in the USB interface control section 11 until the EP 111 becomes full. When the EP 111 becomes full, the USB interface control section 11 transfers the write data to the memory control section 15 through the internal bus 12. It should be noted that the interface between the disk storage apparatus 10 and the host apparatus 20 is not limited to the USB system. Alternatively, an interface that has a transfer rate equal to or higher than that of the USB, such as IEEE 1394, may instead be used.

The internal bus 12 is a transmission path that transmits commands and data between individual modules of the disk storage apparatus 10.

The memory control section 15 writes write data obtained from the USB interface control section 11 through the internal bus 12 to a write buffer disposed in the buffer memory 16.

The buffer memory 16 includes a write buffer that temporarily stores write data to be transferred to the HDD 17 and a read buffer that temporarily stores read data transferred from the HDD 17 before transferred to the host apparatus 20.

The interface control section 13 is a module that controls an interface between the internal bus 12 and the HDD 17.

The control section 14 converts a write command (for example, SCSI Write (1) command) into a write command in a format that can be interpreted by the HDD 17 (for example, an ATA command) and supplies the converted write command to the HDD 17 through the interface control section 13.

In addition, the control section 14 pre-defines an internal LBA space in which blocks in a predetermined unit are successively and equally allocated to a plurality of zones that divide the disk storage area from a beginning LBA of an external LBA space allocated to the disk storage area whose transfer rate spatially changes in the HDD 17. The control section 14 performs a process of replacing an LBA value that indicates a data write location and that is contained in each write command received from the host apparatus 20 with an LBA value in the internal LBA space. The external LBA space is an LBA space allocated to the disk storage area that is used by the host apparatus 20. In addition, the control section 14 cyclically changes a write target zone to be selected, prioritizes at least one write command for the currently selected zone, and controls the HDD 17 to execute the writing process for the zone in the priority order of the write commands.

Although the internal LBA in which blocks in a predetermined unit are successively and equally allocated to a plurality of zones that divide the disk storage area from a beginning LBA of an external LBA space allocated to the disk storage area whose transfer rate spatially changes in the HDD 17 is pre-defined, each block may not necessarily be allocated to each zone equally depending on the size of each zone, the number of zones, the capacity of each block, and so forth.

The CPU 19 performs overall control on the whole disk storage apparatus 10, for example, to exchange commands and data between the modules through the internal bus 12. The memory 18 is used as a work area and so forth for the memory control section 15 and the CPU 19.

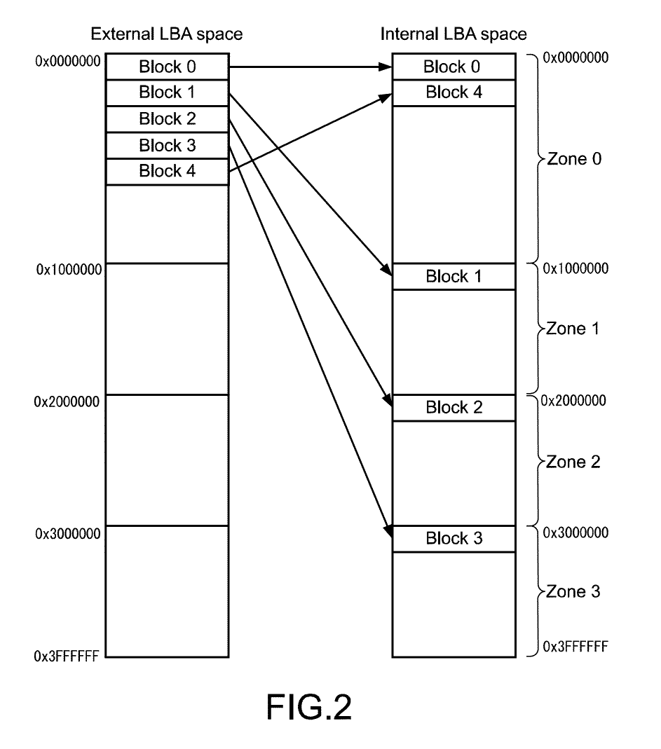

Next, with reference to FIG. 2, a relationship between the external LBA space and the internal LBA space will be described in detail.

In the example shown in FIG. 2, the internal LBA space is defined such that the disk storage area is divided by a predetermined size of, for example, 8 GB (gigabytes) into four zones 0, 1, 2, and 3 from the outermost circumference (beginning LBA) where the transfer rate is the maximum, and blocks in a predetermined unit of, for example, 2 MB (megabytes) (address blocks) are allocated to the zones 0, 1, 2, and 3 from the beginning LBA of the external LBA space.

It is assumed that a FAT 32 file system is used in this example. However, when another file system is used, the internal address space corresponding to the external address space of the disk storage area can also be defined. In this example, the total capacity of the HDD 17 is 32 GB. The minimum LBA and the maximum LBA of the internal LBA space of 32 GB are 0x0000000 and 0x3FFFFFF, respectively. When write data is video data, 2 MB is equivalent to a reproduction duration for about several hundreds milliseconds to one second.

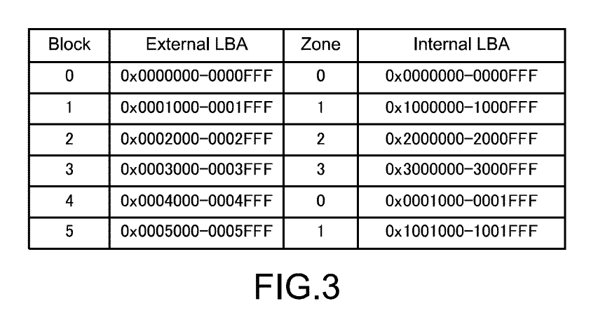

FIG. 3 is a table showing the relationship between external LBAs and internal LBAs in the case where the block size is set to 2 MB and the zone size is set to 8 GB. Specifically, the control section 14 can obtain an internal LBA value from an external LBA value according to the following formula (1).

Internal LBA=ZNm*(0x1000000)+Zof*(0x1000)+Bof (1)

where ZNm is a remainder obtained by dividing, by the number of zones of “4”, a quotient obtained by dividing a given external LBA value by “1000”; Zof is a quotient obtained by dividing, by the number of zones of “4”, the quotient obtained by dividing the given external LBA value by “1000”; and Bof is a remainder obtained by dividing the given external LBA value by “1000”. By this calculation, as shown in FIG. 3, the internal LBA values corresponding to the external LBA values can be obtained. When an internal LBA is obtained, a zone number that includes the internal LBA can also be obtained.

It should be noted that in this embodiment of the present invention, the total capacity of the HDD 17, the zone size, the number of zones, and the block size are not limited to the foregoing values.

Next, a description will be given on an operation when a write command is received from the host apparatus 20 in the disk storage apparatus 10.

When a write command (SCSI Write (10) command) is sent from the host apparatus 20 to the disk storage apparatus 10, the disk storage apparatus 10 sends back ACK that represents write permission to the host apparatus 20. The host apparatus 20 confirms that ACK is sent back, and then transfers write data to the disk storage apparatus 10.

The disk storage apparatus 10 temporarily writes the write data transferred from the host apparatus 20 to the EP 111 disposed in the USB interface control section 11. When the EP 111 becomes full, the disk storage apparatus 10 transfers the write data stored in the EP 111 to the memory control section 15 through the internal bus 12. The memory control section 15 causes the write data to be stored in the buffer memory 16 (write buffer).

In addition, the USB interface control section 11 of the disk storage apparatus 10 sends the write command, which has been received from the host apparatus 20, to the control section 14 through the internal bus 12. The control section 14 processes the write command as follows.

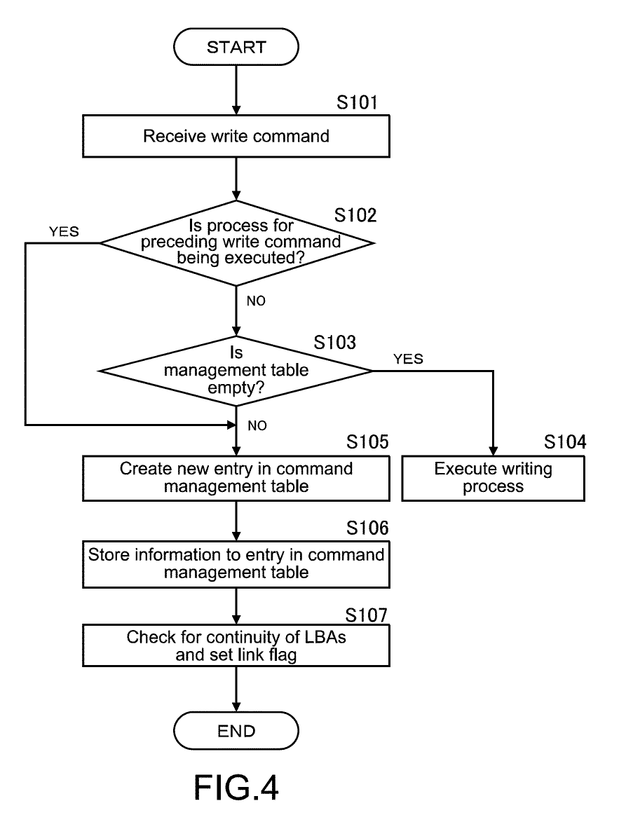

FIG. 4 is a flowchart showing a process flow performed by the control section 14 in response to a write command. When the control section 14 receives a write command (Step S101), the control section 14 judges whether or not the writing process in response to the preceding write command is being executed (Step S102). If the writing process in response to the preceding write command is not being executed (NO at Step S102), the control section 14 judges whether or not a command management table stored in the memory 18 is currently empty (Step S103). The command management table refers to a table that stores information with which write commands sent from the host apparatus 20 are managed. The command management table will be described later in detail.

If the command management table is empty (YES at Step S103), the control section 14 converts the received write command into an ATA command and sends the ATA command to the HDD 17 through the interface control section 13 so as to cause the HDD 17 to execute the writing process (Step S104). Thus, regarding a write command newly received when write commands from the host apparatus 20 are not so frequently issued and the HDD 17 is not currently executing the writing process, the control section 14 immediately converts the newly received write command into an ATA command and sends the ATA command to the HDD 17 to execute the writing process.

When the control section 14 receives a new write command from the host apparatus 20 before the writing process for the preceding write command is completed, for example, when the control section 14 successively receives a plurality of write commands from the host apparatus 20, the control section 14 performs the following control (YES at Step S102). The control section 14 creates a new entry in the command management table (Step S105) and stores to the entry each piece of information obtained based on the write command received from the host apparatus 20 (Step S106). In other words, the control section 14 obtains an internal LBA corresponding to an external LBA contained in the write command from the foregoing formula (1) and stores the obtained internal LBA, a zone number to which the internal LBA belongs, and a write buffer address at which the write data as a write target of the write command is stored to the newly created entry in the command management table. Since an LBA contained in a write command received from the host apparatus 20 is constituted of a start LBA and an end LBA, a start LBA and an end LBA of an internal LBA are obtained and stored to the command management table.

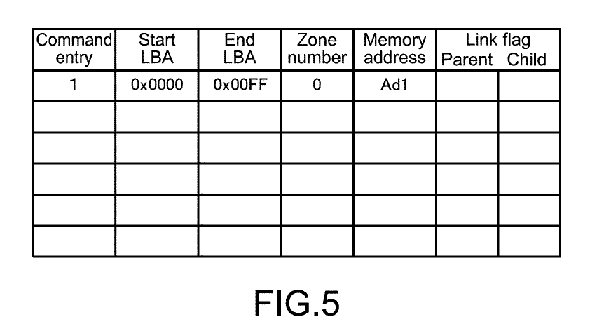

FIG. 5 is a diagram showing the command management table in this situation.

As shown in FIG. 5, each entry of the command management table includes an entry number, start LBA, end LBA, zone number, memory address, and link flag. The start LBA is an internal LBA corresponding to a start LBA contained in the write command. The end LBA is an internal LBA corresponding to an end LBA contained in the write command. The zone number is a zone number to which the start LBA and the end LBA belong. The memory address is a write buffer address at which write data is stored. The link flag is information that represents the relationship between a parent and a child in a case where internal LBAs of entries stored in the command management table are continuous. In FIG. 5, since only one entry is stored in the command management table, a value indicating that there is no link (no connection (NC)) is written in the link flag.

Let us return to the flowchart shown in FIG. 4.

The control section 14 checks for the relationship of links of LBAs of all the entries in the command management table and writes the link flag that represents the relationship between the parent and child to each entry that has such a relationship. The method of setting the link flag in the case where an entry is added to the command management table will be described.

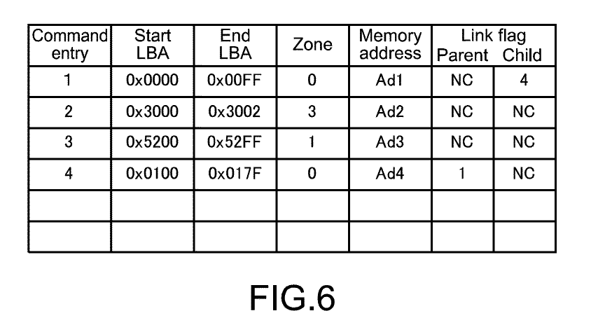

FIG. 6 shows an example of the command management table at the time when three entries (second to fourth entries) are added to the command management table shown in FIG. 5. After the start LBA, end LBA, zone number, and memory address have been stored to the fourth entry, the control section 14 checks for the relationship of links of the internal LBA (start LBA and end LBA) of the newly created entry, the fourth entry, and the internal LBA (start LBA and end LBA) of each of other entries and determines that the internal LBA of the fourth entry and the internal LBA of the first entry have the relationship of links.

The control section 14 checks for the relationship of links of the internal LBAs in such a manner that whether or not the start LBA of a newly created entry is continuous to the end LBA of another entry and whether or not the end LBA of the newly created entry is continuous to the start LBA of another entry are checked. However, the relationship of links of continuous LBAs that belong to different zones are not checked. In the example shown in FIG. 6, the start LBA of entry number 4 is continuous to the end LBA of entry number 1. If the control section 14 has found such a continuity, the control section 14 writes the link flag that represents the relationship between the parent and the child to entries that have such a relationship. In other words, the control section 14 writes a link flag “1” that denotes that the parent of the entry having an entry number 4 is the entry having an entry number 1 to the entry having the entry number 4. “1” represents the entry having the entry number 1. In addition, the control section 14 writes the link flag “4” that denotes that a child of the entry having the entry number 1 is the entry having the entry number 4. “4” represents the entry having the entry number “4”. In this manner, the link flag is set.

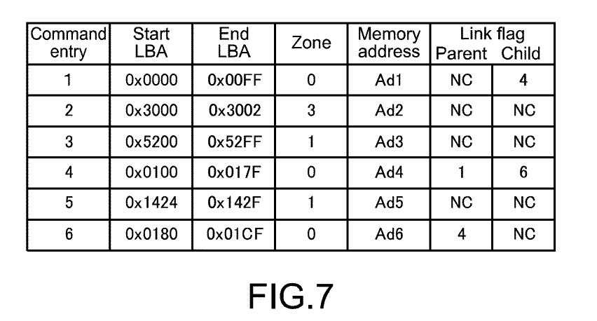

FIG. 7 shows an example of the command management table at a time when two entries (fifth and sixth entries) are also added to the command management table shown in FIG. 6. After the start LBA, end LBA, zone number, and memory address have been written to the sixth entry, the control section 14 checks for the relationship of links of the internal LBA (start LBA and end LBA) of the newly created sixth entry and the internal LBA (start LBA and end LBA) of each of other entries and determines that the end LBA of the forth entry be continuous to the start LBA of the sixth entry. Thus, the control section 14 writes a link flag “6” that denotes that a child of the entry having the entry number 4 is the entry having an entry number 6 to the entry having entry number 4. “6” represents the entry having the entry number 6. In addition, the control section 14 writes link flag “4” that denotes that the parent of the entry having the entry number 6 is the entry having the entry number 4 to the entry having the entry number 6. “4” denotes the entry having the entry number 4. In this manner, the link flag is set again.

If a predetermined event occurs, for example, the host apparatus 20 stops issuing successive write commands or the write buffer becomes full, the control section 14 prioritizes at least one write command for the currently selected zone and controls the HDD 17 to execute the writing process for the prioritized write command for the zone.

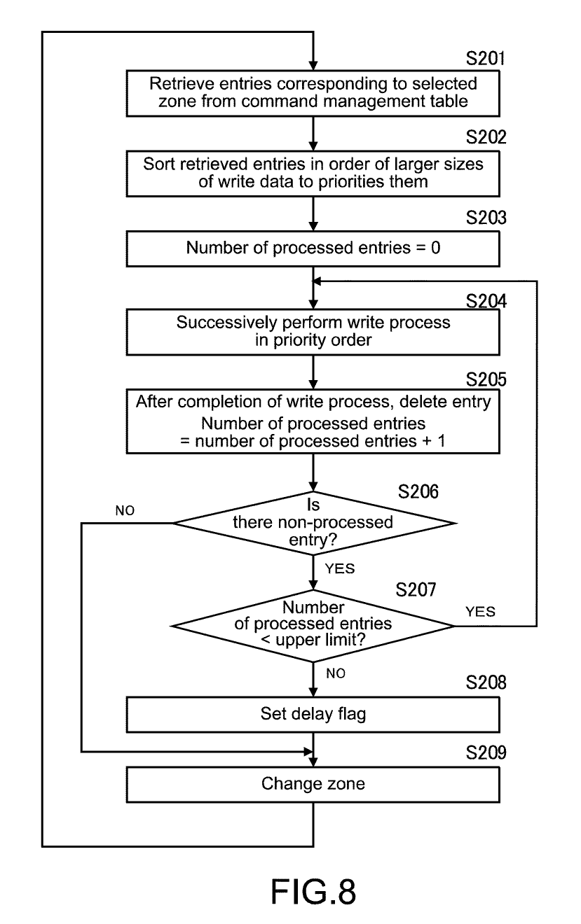

Next, with reference to FIG. 8, control of the writing process performed for each zone of the HDD 17 will be described.

FIG. 8 is a flowchart showing the writing process performed for each zone of the HDD 17. First, the control section 14 selects a zone as a write target zone. The control section 14 performs cyclical changing to select, as a write target zone, one of successive zones of the disk storage area of the HDD 17 in the order of zones 0→1→2→3→0 and so forth. It is assumed that a particular zone (for example, zone 0) has been selected as a write target zone.

First, the control section 14 retrieves entries corresponding to write commands whose write targets are LBAs that belong to zone 0 from the command management table (Step S201).

After that, the control section 14 prioritizes retrieved entries in a descending order of write data sizes obtained from start LBAs and end LBAs (Step S202). In this case, the control section 14 treats a plurality of entries whose link flags represent the relationship between a parent and a child as one entry to be prioritized. In the example of the command management table shown in FIG. 7, there are entry numbers “1”, “4”, and “6” as entries that belong to zone 0. In addition, the link flags of those entries represent the relationship between a parent and a child. Thus, the total size of write data corresponding to those entries becomes a condition in which entries are prioritized. In the example of the command management table shown in FIG. 7, since no other entries belong to zone 0, entry numbers “1”, “4”, and “6” are most highly prioritized.

After at least one write command whose write target is zone 0 is prioritized as described above, the control section 14 initializes a variable that represents the number of processed entries for write commands that have caused the HDD 17 to perform the writing process (number of processed entries) (Step S203), issues write commands (ATA commands) whose write target is zone 0 to the HDD 17 through the interface control section 13 in the priority order of the write commands, and causes the HDD 17 to execute the writing process according to the write commands (Step S204). In this case, the control section 14 converts write commands corresponding to the entries having the relationship between a parent and a child, such as the entries having entry numbers “1”, “4”, and “6”, into an equivalent write command (ATA command) and issues the converted write command to the HDD 17 through the interface control section 13.

After that, the control section 14 receives a notification that indicates the completion of the writing process from the HDD 17 through the interface control section 13, deletes the entry corresponding to the write command for which the HDD 17 has completed the writing process from the command management table, and increments the number of processed entries (Step S205).

After that, the control section 14 judges whether or not the command management table contains a non-processed entry corresponding to a write command for the zone as the write target zone (Step S206). If the command management table contains a non-processed entry (YES at Step S206), the control section 14 checks whether or not the number of processed entries reaches a predetermined upper limit value (Step S207). When the control section 14 determines that the number of processed entries has reached the predetermined upper limit value (NO at Step S207), even if the command management table contains a non-processed entry corresponding to a write command whose write target zone is the selected zone, the control section 14 skips the writing process for the write command corresponding to the non-processed entry and selects the next zone as the write target (Step S209). After that, the control section 14 controls the HDD 17 to execute the writing process for the new zone (for example, zone 1).

Even if the number of processed entries does not reach the upper limit value, after the writing process based on write commands corresponding to all entries whose write target zone is the currently selected zone is completed (NO at Step S206), the control section 14 selects the next zone as the write target zone (Step S209).

A delay flag is set for a non-processed entry in the command management table (Step S208), so that the writing process is performed for a zone corresponding to the non-processed entry when the zone is selected as the write target zone next time or later.

According to this embodiment, the following effects can be obtained.

When the host apparatus 20 transfers write data that is relatively large capacity data such as video stream data to the disk storage apparatus 10, the host apparatus 20 issues write commands such that the storage area is successively used in an ascending order of external LBA values (outer circumference of the disk) and the external LBA space is distributively used (randomly or regularly). According to this embodiment, in this case, blocks each having a predetermined capacity of write data transferred from the host apparatus 20 are allocated to a plurality of zones that divide the external LBA space. In addition, one of the zones is selected as the write target zone by the cyclical changing, and the writing process is performed for the selected zone of the storage medium. Thus, a constantly stable data transfer rate can be secured viewed from the standpoint of the host apparatus.

In addition, in the zone-based writing process, the control section 14 prioritizes write commands for larger write data over write commands for smaller write data such as those for metadata. Thus, in the zone-based writing process, since the frequency of the seek operation for a short period performed for small size data can be decreased, a constantly stable data transfer rate can be secured.

Moreover, the write control by the disk storage apparatus 10 according to this embodiment does not necessitate a modification for the host apparatus 20. Thus, the disk storage apparatus 10 can perform the write control for various types of host apparatuses.

Next, a modification of this embodiment will be described.

The capacities of individual zones may not necessarily be the same. If the zone-based writing process is started from an outer circumferential zone of the disk, it may be possible that the capacities of the inner circumferential zones of the disk are slightly (by about one to several-block size) smaller than the capacities of the outer circumferential zones. However, unless the capacities of individual zones are nearly the same, when the used capacitance becomes large, there is a risk in which a stable data transfer rate is not secured due to influence of fragmentation or the like.

According to the foregoing embodiment, in the zone-based writing process, the writing process based on write commands corresponding to low-priority entries is skipped until the corresponding zone is selected next time. Non-processed entries for which the writing process has been skipped are left in the command management table. There may be various techniques about when and how write commands corresponding to those entries are processed. For example, history information (delay flag) that represents an entry corresponding to a command for which the writing process has been skipped is managed in the command management table. When the corresponding zone is selected as the write target zone next time, the non-processed entry that remains in the command management table and other entries are prioritized and processed in the priority order of the entries. Alternatively, in order to preferentially treat skipped entries over others, the non-processed entries corresponding to write commands for which the writing process has been skipped may be highly prioritized according to the number of times of skipped writing process, for example.

According to the foregoing embodiment, the HDD 17 is used as a storage medium. In addition, the present invention may also be applied to a case where a plurality of HDDs are used. In this case, storage areas of the plurality of HDDs may be treated as one storage area. An internal LBA space corresponding to an external LBA space allocated to the combined storage area may be pre-defined by the control section 14. Alternatively, an HDD and another type of storage medium, for example, an optical disk drive may be combined, their storage areas may be treated as one storage area, an external LBA space may be allocated to the combined storage area, and an internal LBA space corresponding to the external LBA space may be pre-defined by the control section 14. As a result, an embodiment of the present invention may be applied to disk storage apparatus that use different types of media.

The present invention is not limited to the above embodiment, and may of course be variously modified without departing from the gist of the present invention.

The present application contains subject matter related to that disclosed in Japanese Priority Patent Application JP 2008-165741 filed in the Japanese Patent Office on Jun. 25, 2008, the entire content of which is hereby incorporated by reference.

What is claimed is:

1. A disk storage apparatus to control writing to a storage medium having a storage area to which a first address space constituted of a plurality of blocks is allocated and whose transfer rate spatially changes, the disk storage apparatus comprising:
a command reception section to receive write commands issued from a host apparatus and containing an address of the first address space; and
a control section to perform control to divide the storage area into a plurality of zones, pre-define a second address space in which the plurality of blocks are successively allocated to the plurality of zones from a block of a beginning address of the first address space, replace, for each of the write commands received by the command reception section, the address of the first address space contained therein with an address of the second address space, select one of the plurality of zones as a write target zone by cyclical changing, and perform a writing process to the storage medium for each selected zone.

2. The disk storage apparatus as set forth in claim 1, wherein the control section performs control to prioritize the write commands in a descending order of sizes of write data for the write commands and perform the writing process to the storage medium for each selected zone in a priority order of the write commands.

3. The disk storage apparatus as set forth in claim 2,
wherein the control section performs control to prioritize one write command equivalent to a plurality of write commands having continuous addresses as data write targets in the second address space and perform the writing process based on the prioritized write command.

4. The disk storage apparatus as set forth in claim 3,
wherein when a number of times of the writing process based on the write commands for one of the zones becomes a predetermined upper limit value, regardless of whether a non-processed write command for the zone is left, the control section performs control so that the writing process based on the non-processed write command is skipped and a writing process for next one of the zones is performed.

5. The disk storage apparatus as set forth in claim 4,
wherein when the zone corresponding to the non-processed write command for which the writing process is skipped is selected as the write target zone next time, the control section preferentially performs the writing process based on the non-processed write command.

6. The disk storage apparatus as set forth in claim 1,
wherein the control section performs to treat storage areas of a plurality of storage media of one of a same type and different types as one storage area, pre-define the second address space in which the plurality of blocks are successively allocated to the plurality of zones from the block of the beginning address of the first address space allocated to the one storage area, replace, for each of the write commands received by the command reception section, the address of the first address space contained therein with the address of the second address space, select one of the zones as the write target zone by cyclical changing, and performs the writing process to the storage medium for each selected zone.

7. A computer-storage medium comprising computer-executable instructions and that, when executed, control writing to a storage medium having a storage area to which a first address space is allocated and whose transfer rate spatially changes, the computer-executable instructions causing a computer built in a disk storage apparatus to function as:
a command reception section to receive write commands issued from a host apparatus and containing an address of the first address space; and
a control section to perform control to divide the storage area into a plurality of zones, pre-define a second address space in which a plurality of blocks are successively allocated to the plurality of zones from a block of a beginning address of the first address space, replace, for each of the write commands received by the command reception section, the address of the first address space contained therein with an address of the second address space, select one of the plurality of zones as a write target zone by cyclical changing, and perform a writing process to the storage medium for each selected zone.
